(19) United States
(12) Patent Application Publication
(10) Pub. No.: US 2024/0146638 A1
(43) Pub. Date: May 2, 2024

(54) MOTIF IDENTIFICATION AND ANALYSIS FROM HIGH FREQUENCY NETWORK TELEMETRY

(71) Applicant: Cisco Technology, Inc., San Jose, CA (US)

(72) Inventors: Sambarta Dasgupta, Sunnyvale, CA (US); Mukund Yelahanka Raghuprasad, San Jose, CA (US); Jean-Philippe Vasseur, Saint Martin d'Uriage (FR); Grégory Mermoud, Venthone (CH)

(21) Appl. No.: 17/979,296

(22) Filed: Nov. 2, 2022

(51) Int. Cl. H04L 45/12; H04L 41/22; H04L 45/42

(52) U.S. Cl. CPC H04L 45/123; H04L 41/22; H04L 45/42

(57) ABSTRACT

In one embodiment, a device extracts portions of a timeseries of a network path metric by applying a sliding time window to the timeseries. The device groups a subset of the portions of the timeseries into a motif based on their similarities. The device provides data regarding the motif for display to a user via a user interface. The device receives, from the user interface, a label for the motif indicative of whether the motif is associated with degraded application experience for a particular online application.

### TECHNICAL FIELD

The present disclosure relates generally to computer networks, and, more particularly, to motif identification and analysis from high frequency network telemetry.

### BACKGROUND

With the recent evolution of machine learning, predictive failure detection and proactive routing in a network now becomes possible through the use of machine learning techniques. For instance, modeling the delay, jitter, packet loss, etc. for a network path can be used to predict when that path will violate the service level agreement (SLA) of the application and reroute the traffic, in advance. However, doing so is also not without cost, as needlessly rerouting application traffic can also negatively impact the application experience of a user.

Traditionally, SLA thresholds have been used as a proxy for the true quality of experience (QoE) of an online application from the perspective of the end user. In other words, it is assumed that if the SLA is being violated, the QoE of the application is also degraded. While this may hold true in clear situation of network impairment, some of the more complex types of impairments could go unnoticed by network systems because of the specificity of the impairment definition or because of other factors that limit visibility to such impairments. Moreover, such threshold-based mechanisms rely on long-standing phenomena captured by computing aggregate statistics on the network path metrics (e.g. the average delay, etc.), which is far from being able to capture all network issues that affect application QoE in real-life.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for motif identification and analysis from high frequency network telemetry;

FIGS. 6A-6B illustrate examples of the extraction of snippets from a timeseries;

FIGS. 7A-7B illustrate examples of distance based clustering;

FIGS. 8A-8B illustrate example motifs extracted from timeseries;

FIG. 9 illustrates an example plot showing the recurrence times for different motifs; and

FIG. 10 illustrates an example simplified procedure for motif identification and analysis from high frequency network telemetry.

### DESCRIPTION OF EXAMPLE EMBODIMENTS

Overview According to one or more embodiments of the disclosure, a device extracts portions of a timeseries of a network path metric by applying a sliding time window to the timeseries. The device groups a subset of the portions of the timeseries into a motif based on their similarities. The device provides data regarding the motif for display to a user via a user interface. The device receives, from the user interface, a label for the motif indicative of whether the motif is associated with degraded application experience for a particular online application.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

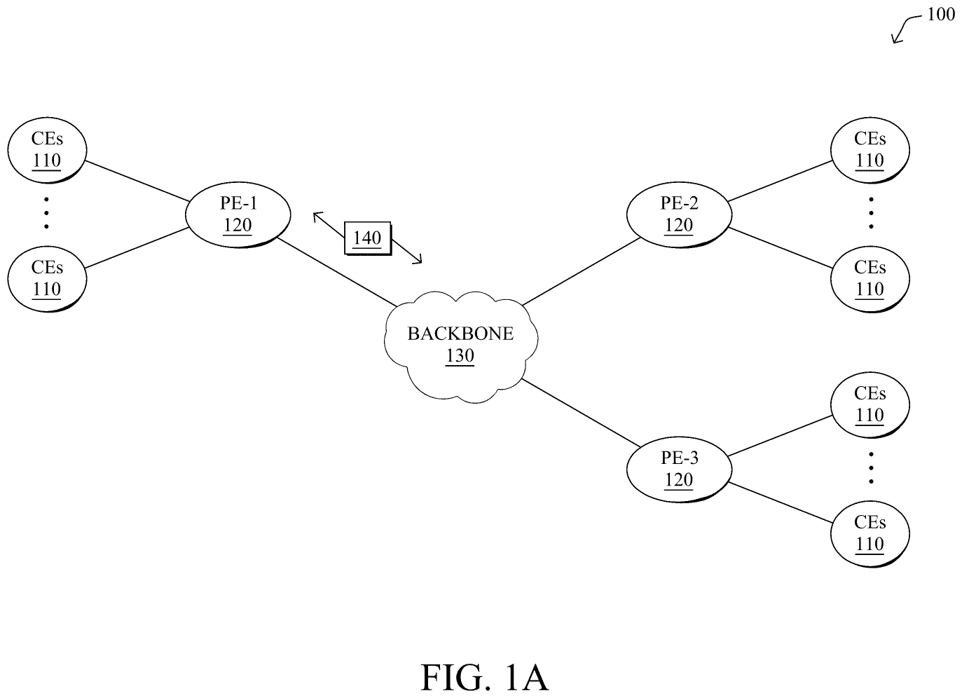

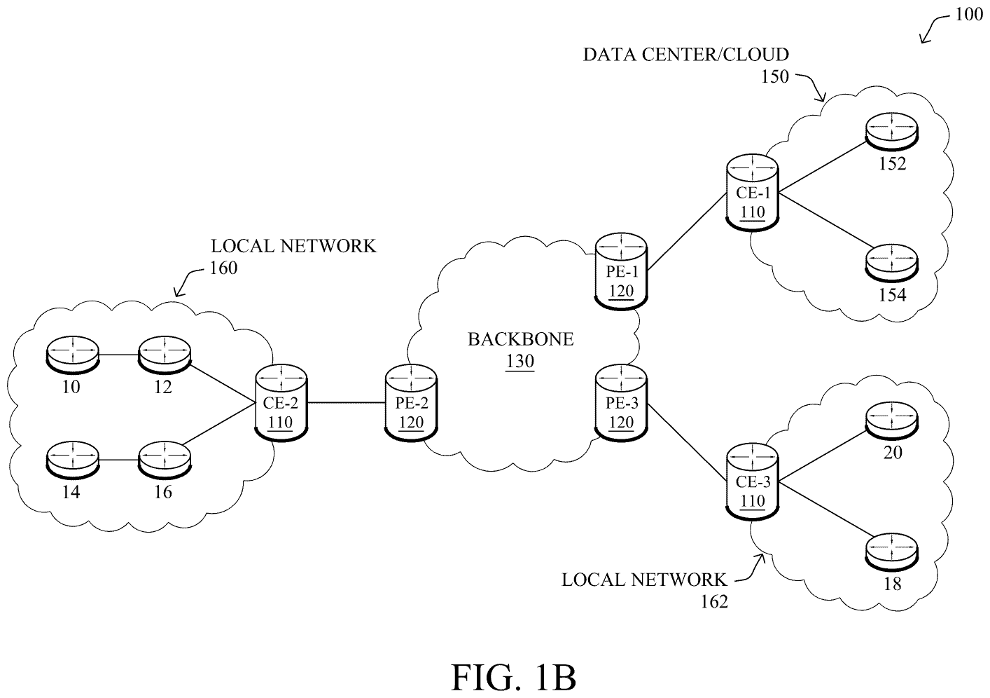

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

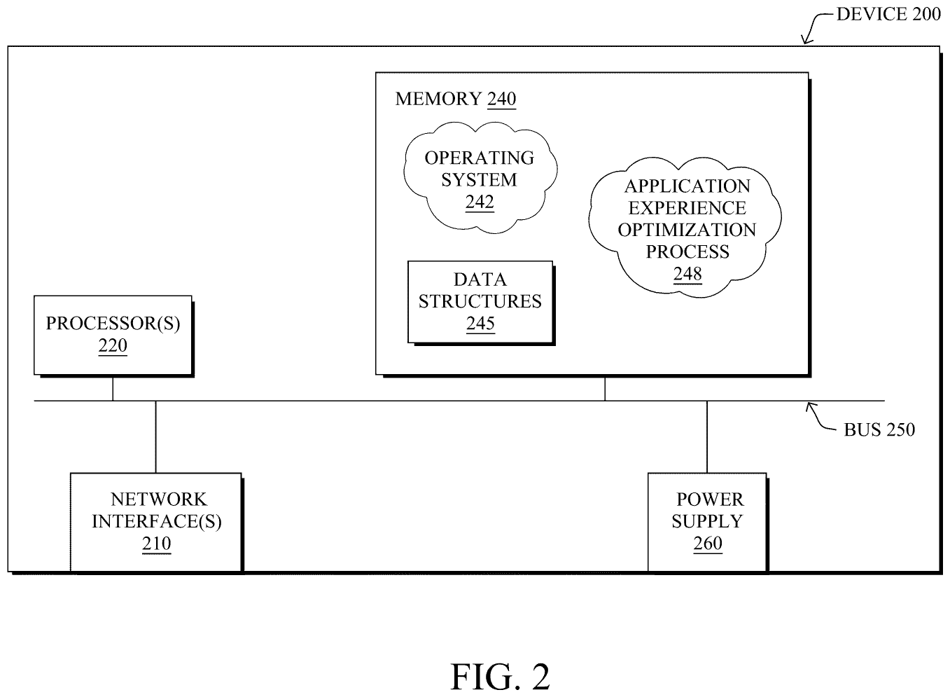

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, application experience optimization process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, application experience optimization process 248 may include computer executable instructions that, when executed by processor(s) 220, cause device 200 to perform the techniques described herein. To do so, in some embodiments, application experience optimization process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 and/or data denoising process may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

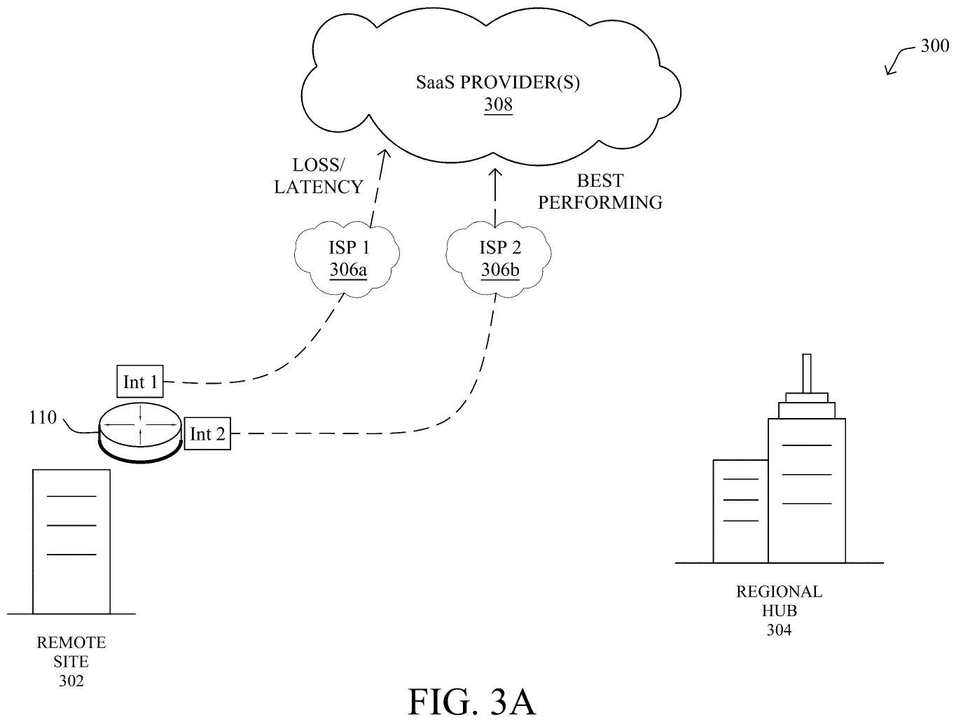

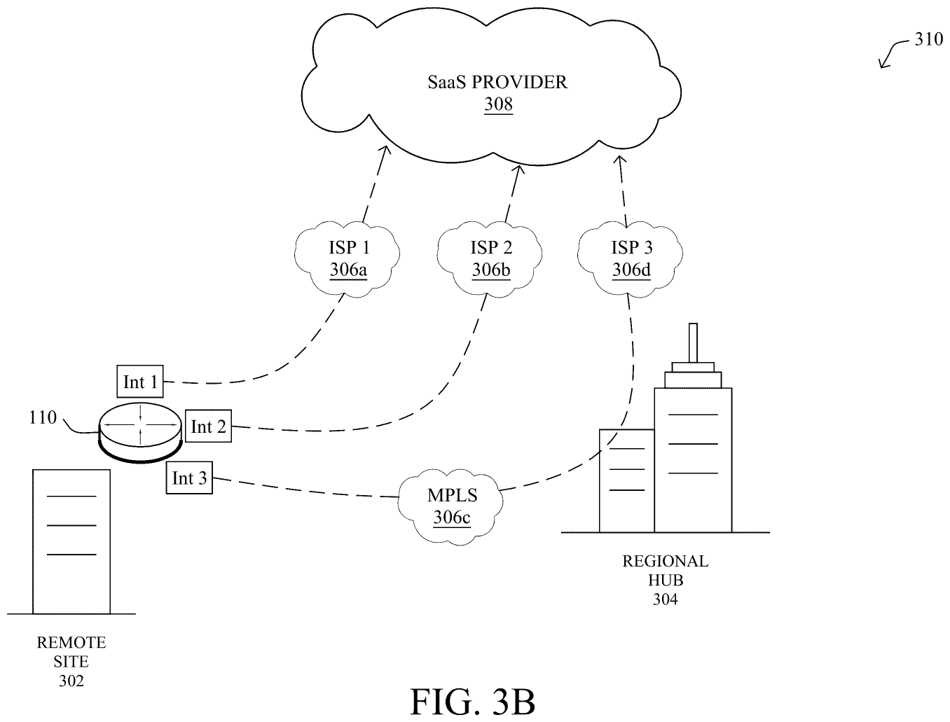

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

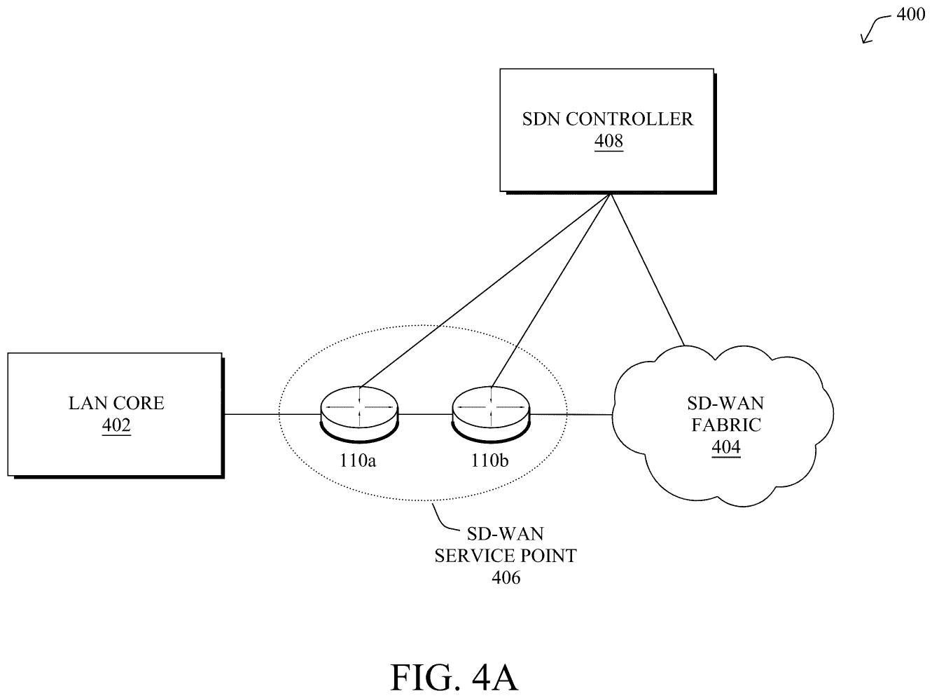

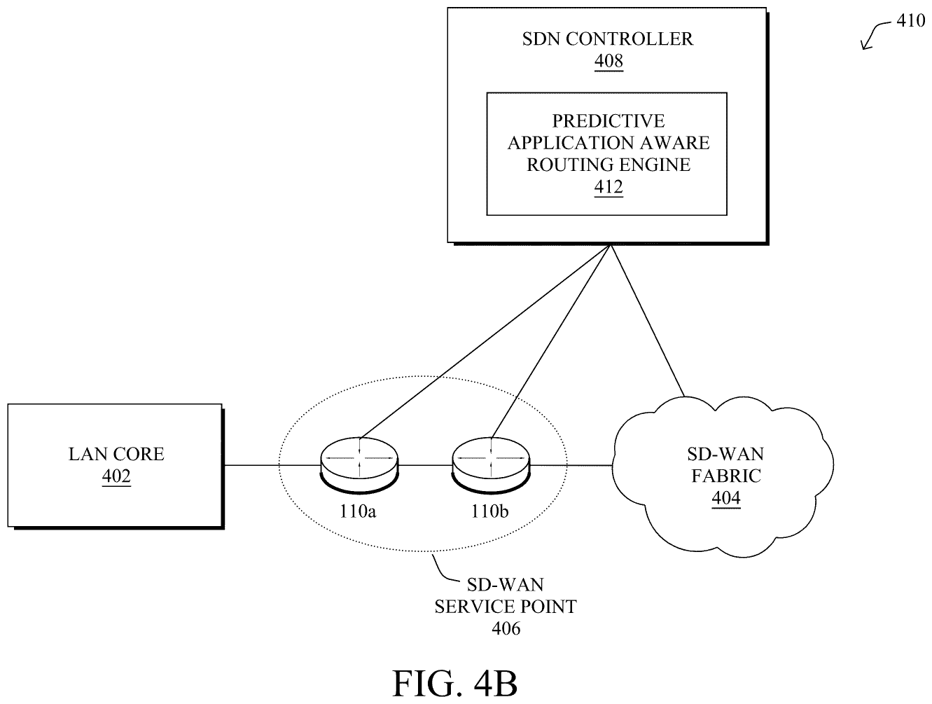

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of application experience optimization process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, application Quality of Experience (QoE) may be degraded because of a wide variety of different types and patterns of network impairments. One observation herein is that such impairments, while complex and dynamic, are also typically repetitive in nature. Current network systems, however, do not consider such complexity when identifying QoE degradation. In terms of identifying “unfavorable” network behavior, predictive application aware routing engine 412 may, in some embodiments, rely on SLA thresholds or a more advanced concept such as application failures which depend on specific threshold for a specific set of path metrics/key performance indicators (KPIs), to infer the QoE of an application. While this may hold true in clear situation of network impairment, some of the more complex types of impairments could go unnoticed by network systems because of the specificity of the impairment definition or because of other factors that limit visibility to such impairments. Moreover, some existing threshold-based mechanisms rely on long-standing phenomena captured by computing aggregate statistics on the network path metrics (e.g. the average delay, etc.), which is far from being able to capture all network issues that affect application QoE in real-life

One example of a factor limiting visibility to the routing system would be the granularity of the network telemetry itself. Consider a network path that undergoes bursts of packet loss whereby each burst drops 25% of the packets and the burst lasts for two seconds and occurs at regular intervals of eight seconds. If the network system measures the packet loss for the path at a granularity of every minute, the average packet loss for that minute will lead to an average packet loss of 5%. While problematic, a packet loss of 5% may also not meet the definition of an application failure (e.g., a condition in which the QoE is considered unacceptable), such as for a video conferencing application. Indeed, many video codecs are now resilient to packet loss and the system may assume that a packet loss of only 5% is not actually degrading the QoE of the application. However, from the perspective of the users, the bursts of packet loss of 25% may very well impact their experience with the application.

Accordingly, any application experience optimization mechanism for a network should be able to identify any prevalent network impairments/patters, referred to herein as “motifs,” and associate them with their respective effects on the QoE of an application. Such visibility can aid predictive application aware routing engine 412 in predicting or tagging application failures at runtime. In addition, identifying such (repetitive) KPI patterns is a must when analyzing application QoE, and can be of the utmost importance for specific link type in the Internet. For instance, when analyzing the latency telemetry for a (LEO) satellite-based communication network, the motifs observed can be attributed to the satellite-switching observed in such a network. Thus, extracting the motifs can be very important so that proactive and/or reactive measures can be taken to optimize the QoE of the online application.

### Motif Identification and Analysis from High Frequency Network Telemetry

The techniques introduced herein allow for the extraction of the most commonly occurring motifs from among the network path metrics/KPIs that also affect the application QoE of an online application. Identifying such motifs/patterns can help identify unnoticed network phenomena that cause QoE degradation. In some aspects, the system may seek feedback from a user regarding the relationship between a particular motif and QoE degradation, such as by asking the user to label the motif as “causes degradation,” “acceptable,” etc. As a result, the techniques herein are more robust than threshold-based techniques and are able to identify complex KPI patterns that indicate QoE degradation, even from high frequency telemetry.

Illustratively, the techniques described herein may be performed by hardware, software, and/or firmware, such as in application experience optimization process 248, which may include computer executable instructions executed by the processor 220 (or independent processor of interfaces 210) to perform functions relating to the techniques described herein.

Specifically, according to various embodiments, a device extracts portions of a timeseries of a network path metric by applying a sliding time window to the timeseries. The device groups a subset of the portions of the timeseries into a motif based on their similarities. The device provides data regarding the motif for display to a user via a user interface. The device receives, from the user interface, a label for the motif indicative of whether the motif is associated with degraded application experience for a particular online application.

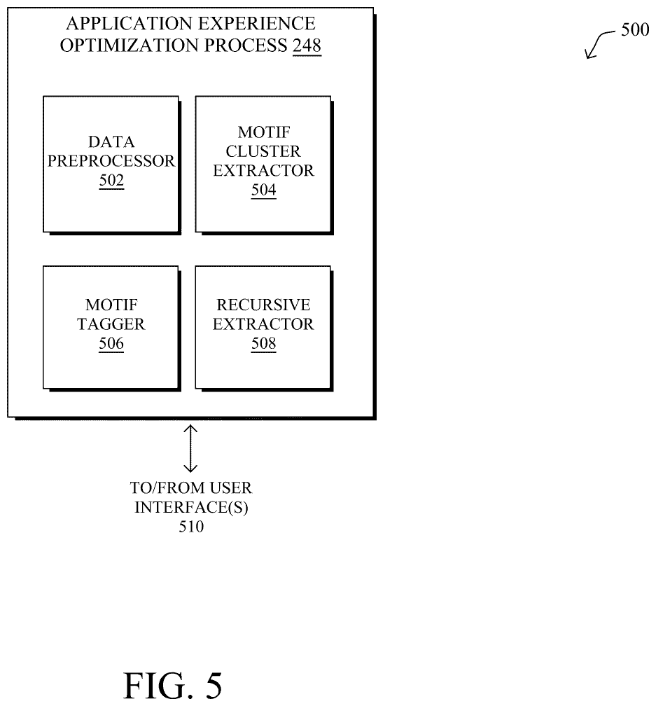

Operationally, FIG. 5 illustrates an example architecture for motif identification and analysis from high frequency network telemetry, according to various embodiments. At the core of architecture 500 is application experience optimization process 248, which may be executed by a controller for a network, a networking device, or another device in communication therewith. For instance, application experience optimization process 248 may be executed by a controller for a network (e.g., SDN controller 408 in FIGS. 4A-4B), a particular networking device in the network (e.g., a router, etc.), another device or service in communication therewith, or the like. In some embodiments, for instance, application experience optimization process 248 may be used to implement a predictive application aware routing engine, such as predictive application aware routing engine 412, or another supervisory service for the network. In other embodiments, application experience optimization process 248 may be used to implement a reactive routing approach in the network.

As shown, application experience optimization process 248 may include any or all of the following components: a data preprocessor 502, a motif cluster extractor 504, a motif tagger 506, and/or a recursive extractor 508. As would be appreciated, the functionalities of these components may be combined or omitted, as desired (e.g., implemented as part of application experience optimization process 248). In addition, these components may be implemented on a singular device or in a distributed manner, in which case the combination of executing devices can be viewed as their own singular device for purposes of executing application experience optimization process 248.

As would be appreciated, application experience optimization process 248 may operate in conjunction with any number of telemetry collection mechanisms, to collect performance metrics regarding the various network paths (e.g., DIA paths, tunnels, etc.), the online applications themselves, or the like. For instance, path metrics may be obtained by sending probes along the various paths/tunnels, such as Bidirectional Forwarding Detection (BFD) or CXP probes, that indicate path metrics such as loss, latency, jitter, throughput, etc. Netflow or IPFIX records represent another potential source of the telemetry data. In some embodiments, application experience optimization process 248 may also obtain telemetry data from the online application(s) under consideration, such as via an application programming interface (API). For instance, application experience optimization process 248 may obtain application feedback as a continuous number or a discrete value (e.g., ‘good’ ‘bad,’ ‘no opinion,’ etc.), or multiple such metrics.

In various embodiments, data preprocessor 502 may take as input the network-level and application-level metrics and processes them for further analysis, as detailed below. To this end, data preprocessor 502 may perform any or all of the following:
Depending on the amount of noise/entropy in the data, process the telemetry to denoise or scale the values of the metrics
Modify the timeseries of all the metrics, to arrive at the required timeseries snippets (e.g., portions of the timeseries extracted using a sliding time window).
If required, filter out the snippets such that only those time-snippets with some form of QoE degradation experience are examined for motifs.

With respect to its denoising operations, data preprocessor 502 may interact with one or more user interfaces 510, allowing the user(s) to specify the parameters and/or denoising technique to use, such as based on the time granularity of the timeseries, the noise distribution of the metrics, etc. In other instances, data preprocessor 502 may use default parameters and a preselected denoising technique. Regardless, if data preprocessor 502 deems a particular timeseries noisy beyond a certain threshold, it may apply denoising to the timeseries.

By way of example, data preprocessor 502 may process a high frequency timeseries of latency metrics measured along a network path. If it finds that the timeseries is noisy and contains relatively smaller fluctuations which could affect the extraction of motifs, then it may initiate denoising. To do so, data preprocessor 502 may clip the timeseries below a certain quantile threshold (e.g., the 25% quantile or other suitable threshold), for instance. In this case, the timeseries may be clipped at such a lower threshold, as doing so preserves the spikes seen at higher ranges of latency which could possibly cause QoE degradations. Depending on the region of interest (higher or lower values) or the nature of the telemetry metric, the appropriate quantile level can be selected either automatically or based on a manually set parameter. In other embodiments, data preprocessor 502 could smooth the timeseries by aggregating over a rolling-window, employing a Fast Fourier Transform (FFT)-based technique where frequencies with lower signal power are removed, or the like.

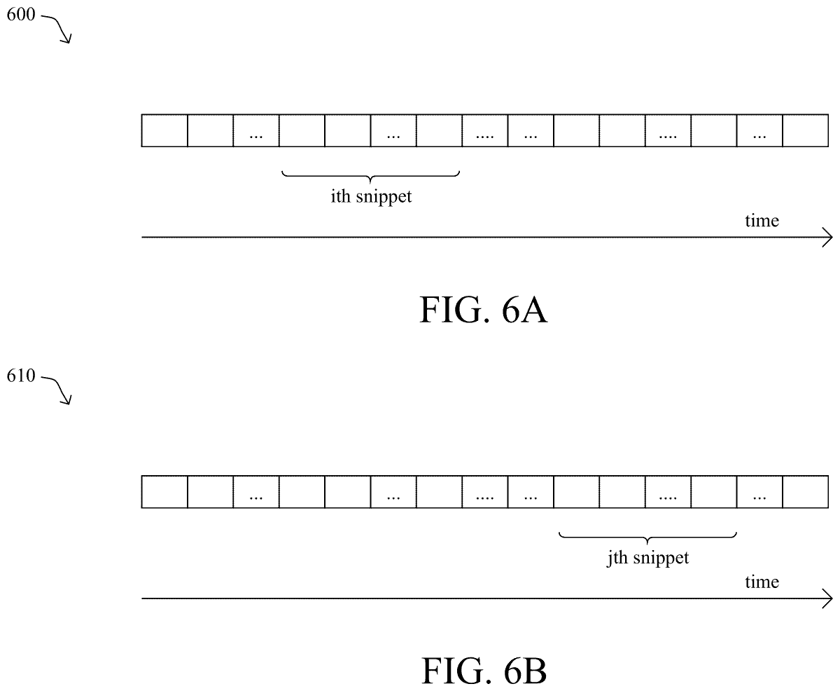

To generate the snippets for a given timeseries, data preprocessor 502 may apply a sliding time window to it. For instance, FIGS. 6A-6B illustrate examples of the extraction of snippets from a timeseries. More specifically, example 600 in FIG. 6A shows the extraction of the i^{th} snippet from a timeseries. Similarly, example 610 in FIG. 6B shows the extraction of the j^{th} snippet from that timeseries. This process may be repeated any number of times, so as to generate a set of snippets to be analyzed.

It is to be noted that each snippet for each metric preferably has a fixed length. For instance, assuming a 500 ms sampling period for the metric, a 1 minute span may have 120 lengths of snippet. In other embodiments, data preprocessor 502 may subject the snippets to a dimensionality reduction technique, such as Principal Component Analysis (PCA), t-Stochastic Neighborhood Estimation (t-SNE), etc., to project the snippets onto to smaller dimensions without losing variability. Such dimensionality reduction can also aid in the better extraction of motifs.

In various embodiments, motif cluster extractor 504 may analyze the timeseries snippets, to identify any motifs present therein. To do so, in some embodiments, motif cluster extractor 504 may perform clustering on the snippets, to generate clusters which possess the same shape. For multivariate cases, the clusters can either be generated in a way that the snippets for only a subset of the different metrics match or the snippets for all of the different metrics match. Furthermore, motif cluster extractor 504 may also prune the clusters so as to ensure that the snippets within a cluster, which share a time-window are considered only once, thereby preventing redundant motifs from being generated.

In some embodiments, motif cluster extractor 504 may also enforce the “shape” or “characteristic” of a motif, as specified by a user via a user interface 510. Some of the characteristics enforced could be duration, duration, observed magnitude of change of the metric, increases in first/second derivative, number of times the motif appears per time-interval, number of times the motif appears in the network (number of nodes), or the like.

In one embodiment, motif cluster extractor 504 may extract motifs by applying distance-based clustering to the timeseries snippets. To do so, motif cluster extractor 504 may create a square matrix with the distance between each snippet. The distance metric can be the L1 norm, L2 norm, Dynamic Time Warping (DTW) distance, or any other distance metric that can be used to measure the similarity of two timeseries snippets. Said differently, the distance is a metric measuring the degree of similarity between two snippets.

For instance, let a first snippet be defined as sᵢ=[xᵢ, xᵢ₊₁, . . . , x_{i+T}] and a second snippet be defined as sⱼ=[xⱼ, xⱼ₊₁, . . . , x_{j+T}]. In such a case, the normalized Euclidean distance (L2) is defined as:

$${d}_{L 2} ( {s}_{i} , {s}_{j} ) = \frac{\sqrt{{\sum }_{k = 0}^{T} {( {x}_{i + k} - {x}_{j + k} )}^{2}}}{\sqrt{{\sum }_{k = 0}^{T} {x}_{i + k}^{2}} \cdot \sqrt{{\sum }_{k = 0}^{T} {x}_{j + k}^{2}}}$$

Similarly, the normalized L1 distance is defined as

$${d}_{L 1} ( {s}_{i} , {s}_{j} ) = \frac{{\sum }_{k = 0}^{T} \vert {x}_{i + k} - {x}_{j + k} \vert}{( {\sum }_{k = 0}^{T} \vert {x}_{i + k} \vert ) \cdot ( {\sum }_{k = 0}^{T} \vert {x}_{j + k} \vert )}$$

The mixed L1/L2 distance is defined as:

$$d ( {s}_{i} , {s}_{j} ) = \frac{{d}_{L 1} ( {s}_{i} , {s}_{j} ) + {d}_{L 2} ( {s}_{i} , {s}_{j} ) + dtw ( {s}_{i} , {s}_{j} )}{3}$$

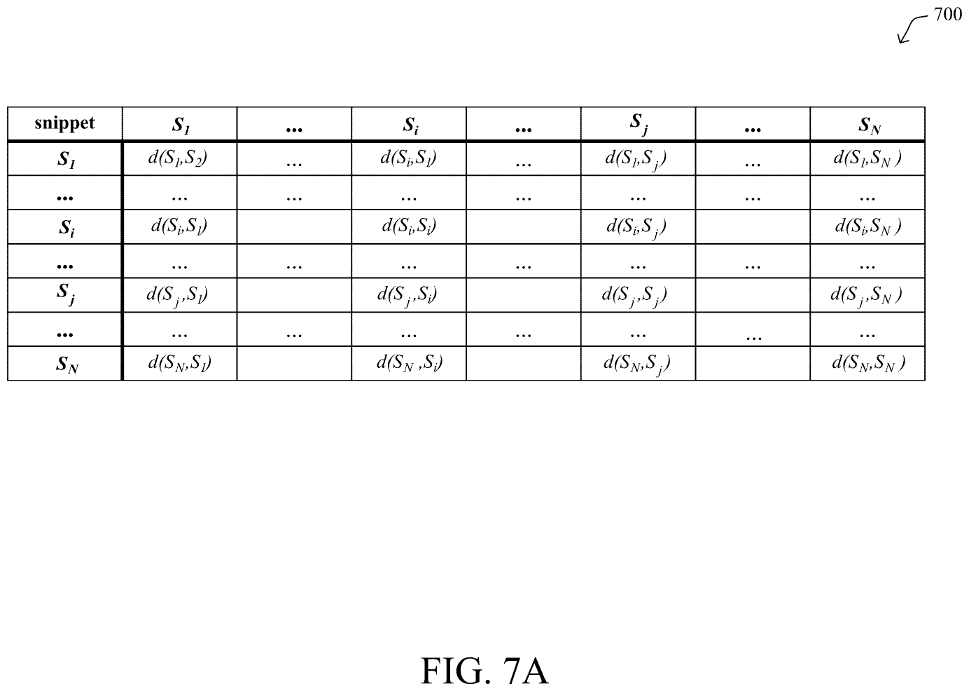

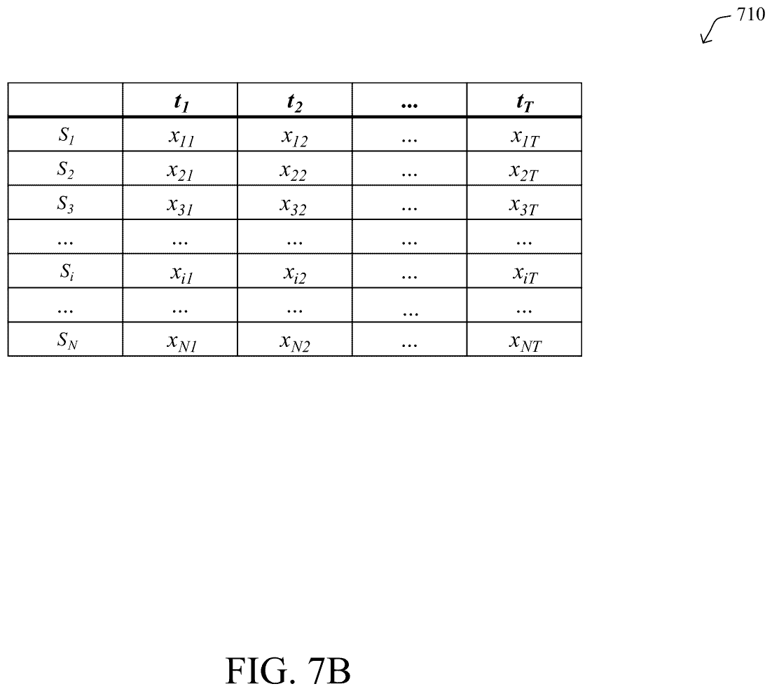

FIG. 7A illustrates an example distance matrix 700 in which the mixed L1/L2 distances between N-number of snippets are stored. In turn, motif cluster extractor 504 may cluster distance matrix 700 into groups using a clustering approach such as Hierarchical Clustering, Spectral Clustering, Density-Based Spatial Clustering of Applications with Noise (DBSCAN), or any other suitable clustering approach. Although, this approach can be a viable solution the computational complexity and storage complexity will be O(n\hat{ }2), where n is the number of snippets.

In another embodiment, motif cluster extractor 504 may perform a Direct Iterative Clustering of Snippets. In this alternative approach, the snippet matrix may take the form of matrix 710 in FIG. 7B. Here, snippet matrix 710 can be further clustered using any suitable clustering approach. The main advantage of using this approach would be to avoid the expensive task of computing a distance matrix. One potential algorithm suitable for the formation of snippet matrix 710 is the KShape algorithm, which uses an iterative approach to clustering, similar to KMeans. Doing so reduces the computational complexity to O(kn), and the storage complexity O(dn), where k is the number of clusters, d is the length of a snippet, and n is the number of snippets.

Once motif cluster extractor 504 has performed its clustering, it may also prune the snippets to ensure that there are no redundant motifs, in some embodiments.

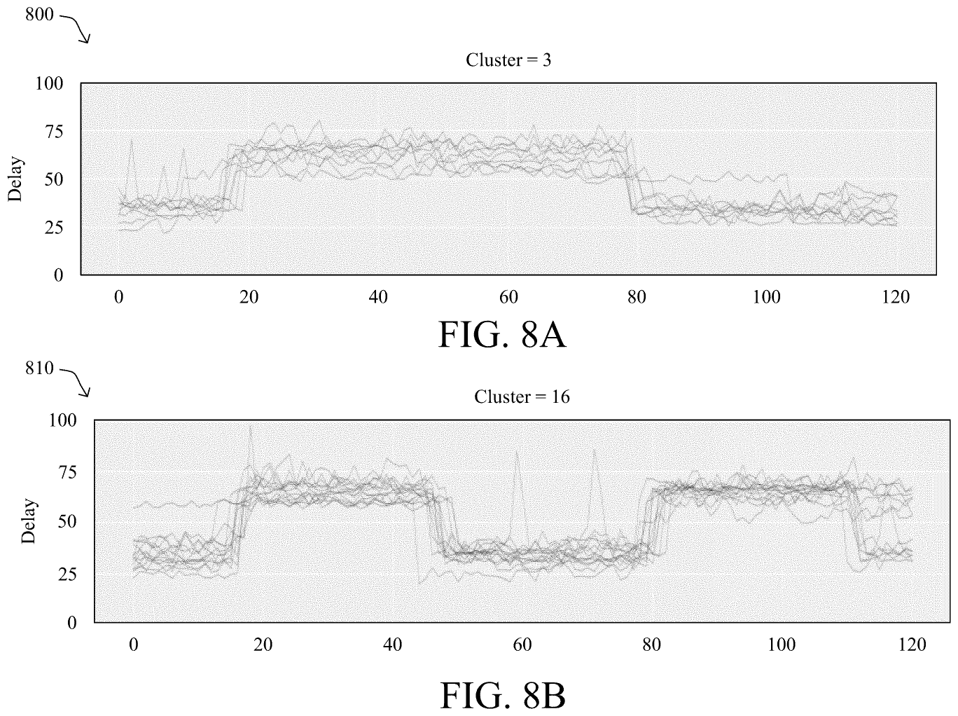

By way of example, FIGS. 8A-8B illustrate example motifs extracted from timeseries, in various embodiments. As shown, each motif may be assigned an identifier that corresponds to its cluster of snippets (e.g., “cluster=x”). For instance, FIG. 8A shows motif 800 extracted from a timeseries of delay metrics. Similarly, FIG. 8B shows motif 810 also extracted from the timeseries. As can be seen, both motifs exhibit very different behaviors. Indeed, it can be observed that different clusters have different motifs of different shapes or structures.

Testing has also revealed that many motifs are recurring, although some are not recurrent at consistent time intervals. Also, if motif cluster extractor 504 perform cluster pruning, the occurrence of the detection of motifs may always be separated from one another by a certain threshold. The pruning stage also enforces the shape of the motif. Accordingly, motif cluster extractor 504 may have the ability to extract clusters with a minimum number of timeseries peaks observed and a minimum number of change-points observed in the delay timeseries.

For simplicity, the clustering shown in FIGS. 8A-8B are for the univariate case (e.g., for a single metric). However, in further embodiments, the techniques herein can be extended as well for the multivariate case (e.g., with timeseries for more than one type of metric) by either performing dimensionality reduction (e.g., as performed by data preprocessor 502) or by performing an additional clustering on top of the initial clustering performed individually for each of the different metrics, treated as a univariate case.

Referring again to FIG. 5, in various embodiments, motif tagger 506 may take as input the motif representations extracted by motif cluster extractor 504 and examines the corresponding application-level and QoE metrics for the snippets belonging to their corresponding clusters. To do so, motif tagger 506 may seek user feedback from one or more user interfaces 510. The action of tagging motifs of interest is extremely important and likely requires subject matters expertise. Indeed, several motifs may be due to known network effect that the user may consider as “of no interest/no real impact on the user QoE” or simply “tolerable.” In other cases, it may be required for motif tagger 506 itself to tag motifs based on their relationship with other KPIs (such as the observed QoE impact, as indicated by the application).

To identify QoE degradations, in one embodiment, motif tagger 506 may analyze the distribution of application-level or QoE metrics to determine if these metrics show degradation or a distribution difference in a statistically significant manner at the time a motif is active (i.e., present in the network). Motif tagger 506 may also generate inferences on the distribution differences identified among the application-level or QoE metrics.

In various embodiments, motif tagger 506 may present a user interface from which network experts can review the motifs identified by the system along with the corresponding information of the effect on application QoE. Note that a user may decide not to flag a motif even if there is a strong correlation with QoE degradation, such as when the expert does not consider the impact to be important. The experts can then assign, via user interface(s) 510, labels to a motif such as “Harmful,” “Does not affect QoE,” “Affects QoE but not Predictable,” etc. The type of the label and its criterion can be defined by the expert, in some cases. Motif tagger 506 may also use these assignments from experts as feedback to update its clustering and the adjust the operations of data preprocessor 502 and/or motif cluster extractor 504, to adapt their operations to the subjective views of the experts.

In one embodiment, motif tagger 506 may assign an importance value to a motif, based on the duration of time between consecutive occurrences of the motif. The duration between reoccurrence of the motifs can be used to identify motifs that recur over large time-ranges repetitively as opposed to those which only recur for a certain limited time duration. Such ‘local’ motifs, which could be a result of some temporary influence on the network path, are much less important than motifs which show up regularly over a long-history and indicate a more permanent problem on the path.

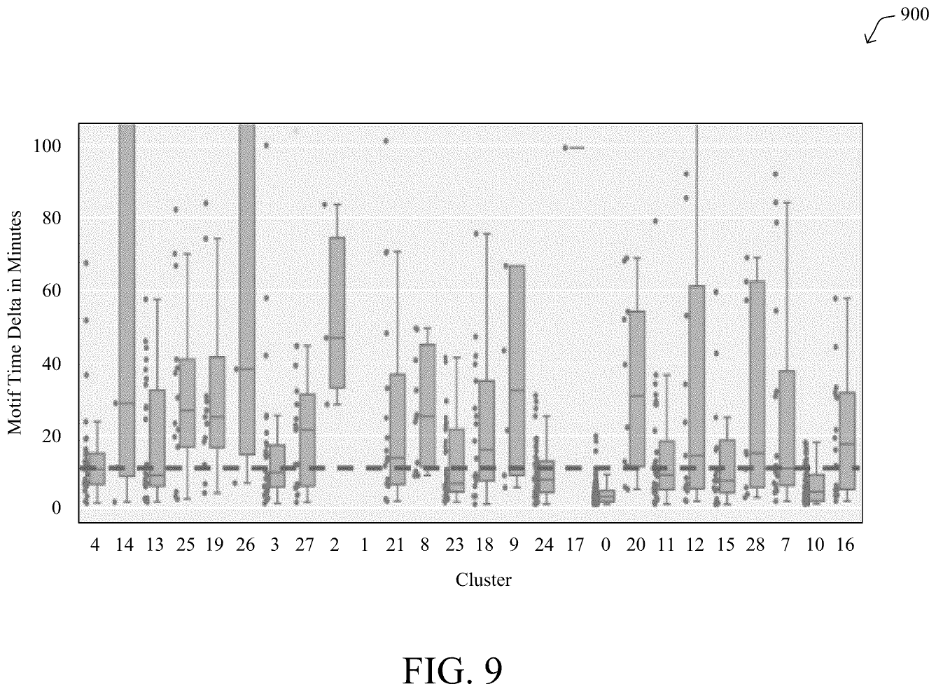

FIG. 9 illustrates an example graph 900 showing the box plot of the time delta between reoccurrence of different motifs, which motif tagger 506 may present to one or more user interfaces 510. The dotted line represents the ten minute threshold. The motif clusters spanning beyond the line are the ones reoccurring in a non-local fashion and, thus, are of importance and can be tagged as important by motif tagger 506.

In another embodiment, motif tagger 506 may show the relative impact on QoE for a given motif as well as the distribution of the number of users that have been impacted. Indeed, it has been seen in real-life network that the number of users impacted may greatly vary between networks and sites. For instance, the network administrator may decide that a given motif may have a very undesirable impact on the QoE for an application of importance but would not impact enough users to warrant being tagged.

Referring again to FIG. 5, application experience optimization process 248 may also include recursive extractor 508. As noted above, the motif extraction operation can be computationally intensive. Furthermore, the size of the snippet has a significant impact on the process of motif extraction and clustering. Accordingly, the aim of recursive extractor 508 is to perform a recursive analysis of the tagged motif so as to ‘zoom-in’ and identify sub-motifs which are more correlated with the events of interest (e.g., those impacting the QoE).

More specifically, recursive extractor 508 may extract motifs of shorter time-intervals leading to motifs which have higher/closer correlation with QoE degradation. Of course, if snippet have too long of a duration, this may lead to missing motif of interest. Various approaches may be taken for such recursive extraction. For instance, recursive extractor 508 can start with a snippet interval of a certain standard length, extract motifs clusters, and associate them with QoE. Then, in the absence of motifs of interest, iterate the process with shorter snippets. The iteration may also focus only on the specific regions with suspected QoE degradation within the initially extracted motif-clusters. In addition, recursive extractor 508 can also further decompose the already tagged motifs into motifs of shorter intervals by recursively zooming on the tagged motif-cluster. Such recursive extraction can help identify the actual disruptive part of a larger motif and also the corresponding early-sign for such repetitive disruptions.

Any such tagged motifs can then be stored in a database for retrieval by a routing engine (e.g., predictive application aware routing engine 412) and/or for presentation to a user, to better understand the impact of the different behaviors on the QoE of an application.

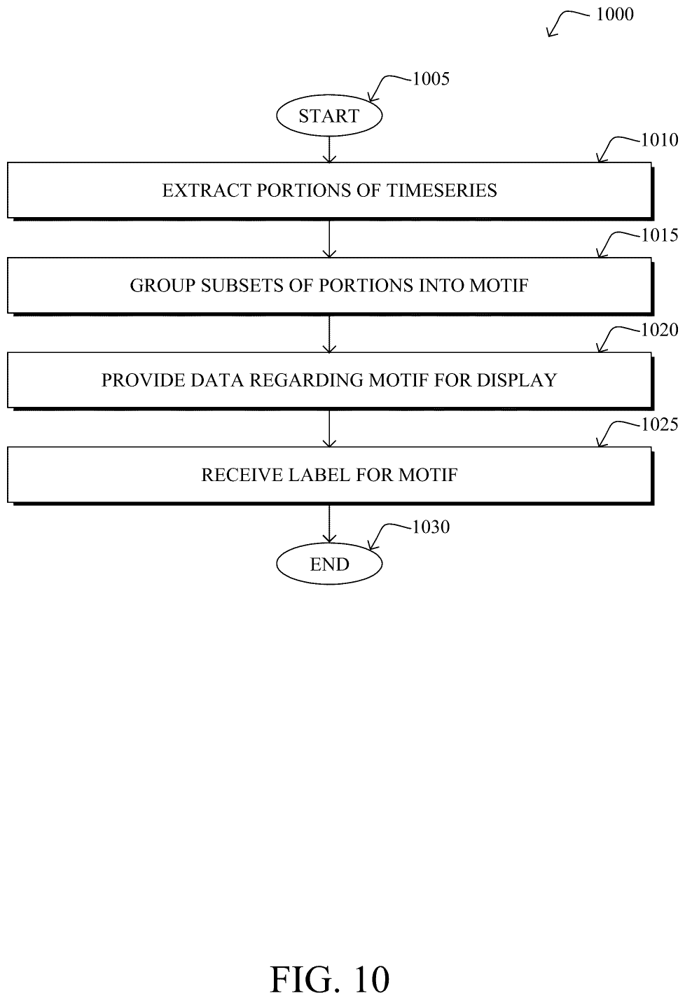

FIG. 10 illustrates an example simplified procedure 1000 (e.g., a method) for motif identification and analysis from high frequency network telemetry, in accordance with one or more embodiments described herein. For example, a non-generic, specifically configured device (e.g., device 200), such as controller for a network (e.g., an SDN controller, a cloud-based device, etc.), an edge router, or other device in communication therewith, may perform procedure 1000 by executing stored instructions (e.g., application experience optimization process 248). The procedure 1000 may start at step 1005, and continues to step 1010, where, as described in greater detail above, the device may extract portions of a timeseries of a network path metric by applying a sliding time window to the timeseries. In some embodiments, the network path metric comprises at least one of: packet loss, jitter, delay, or throughput. In one embodiment, the timeseries is a multivariate timeseries of a plurality of network path metrics.

At step 1015, as detailed above, the device may group a subset of the portions of the timeseries into a motif based on their similarities. In some embodiments, the device may also recursively decrease the sliding time window into a smaller time interval, based on the label, and form another motif in part by applying the smaller time interval to the timeseries. In one embodiment, the device may group the subset into the motif in part by computing distances between portions of the timeseries in the subset and one or more other portions outside of the subset.

At step 1020, the device may provide data regarding the motif for display to a user via a user interface, as described in greater detail above. In some embodiments, the device may also determine an amount of time between instances of the motif occurring and provide an indication of the amount of time for display to the user via the user interface. In further embodiments, the device may also provide data regarding a number of users potentially affected by the motif for display by the user interface, in conjunction with the data regarding the motif.

At step 1025, as detailed above, the device may receive, from the user interface, a label for the motif indicative of whether the motif is associated with degraded application experience for a particular online application. In some embodiments, the motif is used to make a routing decision regarding traffic of the particular online application, based on its label. In one embodiment, the particular online application is a SaaS application.

Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for motif identification and analysis from high frequency network telemetry, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
extracting, by a device, portions of a timeseries of a network path metric by applying a sliding time window to the timeseries;
grouping, by the device, a subset of the portions of the timeseries into a motif based on their similarities;
providing, by the device, data regarding the motif for display to a user via a user interface; and
receiving, at the device and from the user interface, a label for the motif indicative of whether the motif is associated with degraded application experience for a particular online application.

2. The method as in claim 1, wherein the network path metric comprises at least one of: packet loss, jitter, delay, or throughput.

3. The method as in claim 1, further comprising:
determining, by the device, an amount of time between instances of the motif occurring; and
providing, by the device, an indication of the amount of time for display to the user via the user interface.

4. The method as in claim 1, wherein the timeseries is a multivariate timeseries of a plurality of network path metrics.

5. The method as in claim 1, further comprising:
recursively decreasing the sliding time window into a smaller time interval, based on the label; and
forming another motif in part by applying the smaller time interval to the timeseries.

6. The method as in claim 1, wherein grouping the subset of the portions of the timeseries into the motif based on their similarities comprises:
computing distances between portions of the timeseries in the subset and one or more other portions outside of the subset.

7. The method as in claim 1, wherein the motif is used to make a routing decision regarding traffic of the particular online application, based on its label.

8. The method as in claim 1, further comprising:
providing, by the device, data regarding a number of users potentially affected by the motif for display by the user interface, in conjunction with the data regarding the motif.

9. The method as in claim 1, wherein the label indicates that the motif does degrade an application experience for the particular online application but that the user does not believe this degradation to be important.

10. The method as in claim 1, wherein the particular online application is a software-as-a-service (SaaS) application.

11. An apparatus, comprising:
one or more network interfaces;
a processor coupled to the one or more network interfaces and configured to execute one or more processes; and
a memory configured to store a process that is executable by the processor, the process when executed configured to:
extract portions of a timeseries of a network path metric by applying a sliding time window to the timeseries;
group a subset of the portions of the timeseries into a motif based on their similarities;
provide data regarding the motif for display to a user via a user interface; and
receive, from the user interface, a label for the motif indicative of whether the motif is associated with degraded application experience for a particular online application.

12. The apparatus as in claim 11, wherein the network path metric comprises at least one of: packet loss, jitter, delay, or throughput.

13. The apparatus as in claim 11, wherein the process when executed is further configured to:
determine an amount of time between instances of the motif occurring; and
provide an indication of the amount of time for display to the user via the user interface.

14. The apparatus as in claim 11, wherein the timeseries is a multivariate timeseries of a plurality of network path metrics.

15. The apparatus as in claim 11, wherein the process when executed is further configured to:
recursively decrease the sliding time window into a smaller time interval, based on the label; and
form another motif in part by applying the smaller time interval to the timeseries.

16. The apparatus as in claim 11, wherein the subset is formed by: computing distances between portions of the timeseries in the subset and one or more other portions outside of the subset.

17. The apparatus as in claim 11, wherein the motif is used to make a routing decision regarding traffic of the particular online application, based on its label.

18. The apparatus as in claim 11, wherein the process when executed is further configured to:
provide data regarding a number of users potentially affected by the motif for display by the user interface, in conjunction with the data regarding the motif.

19. The apparatus as in claim 11, wherein the label indicates that the motif does degrade an application experience for the particular online application but that the user does not believe this degradation to be important.

20. A tangible, non-transitory, computer-readable medium storing program instructions that cause a device to execute a process comprising:
extracting, by the device, portions of a timeseries of a network path metric by applying a sliding time window to the timeseries;
grouping, by the device, a subset of the portions of the timeseries into a motif based on their similarities;
providing, by the device, data regarding the motif for display to a user via a user interface; and
receiving, at the device and from the user interface, a label for the motif indicative of whether the motif is associated with degraded application experience for a particular online application.
